(19) United States
(12) Patent Application Publication
(10) Pub. No.: US 2025/0238998 A1
(43) Pub. Date: Jul. 24, 2025

(54) Electronic Device for Blending Secure Camera Pixels

(71) Applicant: Apple Inc., Cupertino, CA (US)

(72) Inventors: Rory J. Driscoll, Hermosa Beach, CA (US); Ahmer A. Khan, San Jose, CA (US); Gurjeet S. Saund, Saratoga, CA (US); Chiraag Juvekar, San Carlos, CA (US)

(21) Appl. No.: 18/940,168

(22) Filed: Nov. 7, 2024

Related U.S. Application Data
(60) Provisional application No. 63/623,050, filed on Jan. 19, 2024.

(51) Int. Cl. G06T 15/00; G06T 3/14

(52) U.S. Cl. CPC G06T 15/005; G06T 3/14

(57) ABSTRACT

An electronic device can include one or more cameras that are part of a secure domain and configured to acquire an image, a first subsystem that is part of a general purpose domain and configured to render one or more content layers, a second subsystem that is part of the secure domain and configured to process the acquired image to produce a processed image without revealing the acquired image to the general purpose domain, and a third subsystem that is part of the secure domain and configured to combine the processed image with the one or more content layers. The content layers can include a camera mask and a virtual content layer. The virtual content layer can include one or more user interface elements. The camera mask can be rendered based on camera-independent alpha values. The virtual content layer can be rendered based on black camera pixel values.

This application claims the benefit of U.S. Provisional Patent Application No. 63/623,050, filed Jan. 19, 2024, which is hereby incorporated by reference herein in its entirety.

### FIELD

This disclosure relates generally to electronic devices and, more particularly, to electronic devices with transparent displays.

### BACKGROUND

Electronic devices can include transparent displays that present images close to a user's eyes. The transparent displays permit viewing of a user's physical environment through the transparent displays. For example, extended reality headsets may include transparent displays. Such electronic devices with transparent displays can include cameras for capturing an image of the surrounding environment. It is within this context that the embodiments herein arise.

### SUMMARY

An aspect of the disclosure provides a method of operating an electronic device such as a head-mounted device, the method including: with one or more image sensors within a secure domain, acquiring an image; with a first subsystem within a general purpose domain separate from the secure domain, rendering one or more content layers; with a second subsystem within the secure domain, processing the acquired image to produce a processed image without conveying the acquired image to the general purpose domain; and with a third subsystem within the secure domain, combining the processed image with the one or more content layers. The first subsystem can include a graphics rendering engine configured to render a virtual content layer. The virtual content layer can include one or more user interface elements. The graphics rendering engine can further be configured to render a camera mask. The second subsystem can include an image transform subsystem configured to transform the acquired image based on perspective data. The third subsystem can include a compositor subsystem configured to compute a product of the processed image and the camera mask and further configured to compute a sum of the product and the virtual content. The method can further include using a rendering management subsystem within the general purpose domain to control blending operations at the first subsystem and blending operations at the second subsystem.

An aspect of the disclosure provides a method of operating an electronic device, the method including: with one or more cameras, acquiring an image having camera pixel values; with a graphics rendering engine, rendering a camera mask having alpha values that are independent of the camera pixel values; and with a compositor, masking the image with the camera mask. The method can further include obtaining the alpha values based on a shape of the camera mask. The method can further include transforming the image based on the shape of the camera mask before masking the image with the camera mask. The method can further include: with the graphics rendering engine, rendering a virtual content layer; and with the compositor, adding the virtual content layer to the masked image. The graphics rendering engine can be part of a general purpose domain. The one or more cameras and the compositor can be part of a secure domain that is separate from the general purpose domain. The camera pixel values of the acquired image can remain entirely within the secure domain and can be isolated from the general purpose domain.

An aspect of the disclosure provides a method of operating an electronic device, the method including: with one or more cameras, acquiring an image having camera pixel values; with a graphics rendering engine, rendering a virtual content layer based on black camera pixel values; processing the acquired image to produce a processed image; and producing a composite image based on the processed image and the virtual content layer. The method can include blending the black camera pixel values with foreground pixel values based on alpha values that are independent of the camera pixel values. The method can further include: with the graphics rendering engine, rendering a camera mask; and masking the processed image with the camera mask. The graphics rendering engine can include a subsystem within a general purpose domain. The one or more cameras can include one or more image sensors within a secure domain that is separate from the general purpose domain. The camera pixel values can be isolated from the general purpose domain. One or more processors in the secure domain can be configured to produce the processed image and to produce the composite image.

### BRIEF DESCRIPTION OF THE DRAWINGS

FIG. 1 is a diagram of an illustrative system having a transparent display in accordance with some embodiments.

FIG. 2 is a diagram of an illustrative display output having a portion with sensitive data and having a portion with non-sensitive data in accordance with some embodiments.

FIG. 3 is a diagram of an illustrative display output that includes a camera layer and a virtual content layer in accordance with some embodiments.

FIG. 4 is a diagram of an illustrative system including hardware and/or software subsystems configured to output a composite image based on a camera layer, a camera mask, and a virtual content layer in accordance with some embodiments.

FIG. 5A is a diagram of an illustrative captured image, a portion of which can be used to produce a camera layer in accordance with some embodiments.

FIG. 5B is a diagram of an illustrative transformed image in accordance with some embodiments.

FIG. 6A is a diagram of an illustrative camera mask in accordance with some embodiments.

FIG. 6B is a diagram showing illustrative alpha blending values associated with the camera mask shown in FIG. 6A in accordance with some embodiments.

FIG. 7 is a diagram of an illustrative virtual content or user interface layer in accordance with some embodiments.

FIG. 8 is a diagram of an illustrative composite image in accordance with some embodiments.

FIG. 9 is a flow chart of illustrative steps for operating a system of the type shown in FIG. 4 in accordance with some embodiments.

FIG. 10 is a diagram showing rendering of an illustrative virtual content layer pixel in accordance with some embodiments.

FIG. 11 is a diagram showing rendering of an illustrative camera mask in accordance with some embodiments.

FIG. 12 is a diagram showing how the operations of FIGS. 9-11 can achieve alpha blending via a weighted sum approach in accordance with some embodiments.

### DETAILED DESCRIPTION

A physical environment can refer to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell.

In contrast, an extended reality (XR) environment refers to a wholly or partially simulated environment that people sense and/or interact with via an electronic device. For example, an XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics.

As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment.

Rather than an opaque display, a head mountable system may have a transparent or translucent display. The transparent or translucent display may have a medium through which light representative of images is directed to a person's eyes. The display may utilize digital light projection, organic light-emitting diodes (OLEDs), LEDs, micro light-emitting diodes (uLEDs camera pixel blending alpha values), liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to selectively become opaque. Projection-based systems may employ retinal projection technology that projects graphical images onto a person's retina. Projection systems also may be configured to project virtual objects into the physical environment, for example, as a hologram or on a physical surface.

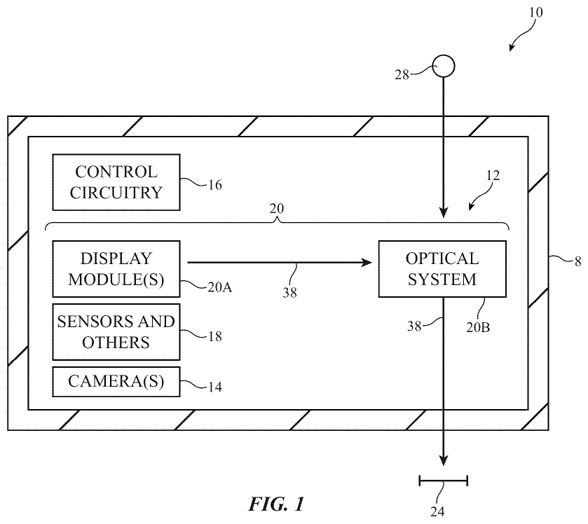

System 10 (sometimes referred to as electronic device 10, head-mounted device 10, etc.) of FIG. 1 may be a head-mounted device having one or more displays. The displays in system 10 may include displays 20 (sometimes referred to as near-eye displays) mounted within support structure (housing) 8. Support structure 8 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display modules such as display modules 20A and one or more optical systems such as optical systems 20B. Display modules 20A may be mounted in a support structure such as support structure 8. Each display module 20A may emit light 38 (image light) that is redirected towards a user's eyes at eye box 24 using an associated one of optical systems 20B. Displays 20 are optional and can be omitted from device 10.

The operation of system 10 may be controlled using control circuitry 16. Control circuitry 16 may be configured to perform operations in system 10 using hardware (e.g., dedicated hardware or circuitry), firmware and/or software. Software code for performing operations in system 10 and other data is stored on non-transitory computer readable storage media (e.g., tangible computer readable storage media) in control circuitry 16. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16. The processing circuitry may include application-specific integrated circuits with processing circuitry, one or more microprocessors, digital signal processors, graphics processing units, a central processing unit (CPU) or other processing circuitry.

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include one or more cameras 14 (sometimes referred to as image sensors 14). Cameras 14 may be used for gathering images of physical objects that are optionally digitally merged with virtual objects on a display in system 10. Input-output devices 12 may include sensors and other components 18 (e.g., accelerometers, gyroscopes, depth sensors, light sensors, haptic output devices, speakers, batteries, wireless communications circuits for communicating between system 10 and external electronic equipment, etc.).

Cameras 14 that are mounted on a front face of system 10 and that face outwardly (towards the front of system 10 and away from the user) may sometimes be referred to herein as outward-facing, external-facing, forward-facing, or front-facing cameras. Cameras 14 may capture visual odometry information, image information that is processed to locate objects in the user's field of view (e.g., so that virtual content can be registered appropriately relative to real-world objects), image content that is displayed in real time for a user of system 10, and/or other suitable image data. For example, outward-facing cameras may allow system 10 to monitor movement of the system 10 relative to the environment surrounding system 10 (e.g., the cameras may be used in forming a visual odometry system or part of a visual inertial odometry system). Outward-facing cameras may also be used to capture images of the environment that are displayed to a user of the system 10. If desired, images from multiple outward-facing cameras may be merged with each other and/or outward-facing camera content can be merged with computer-generated content for a user.

Display modules 20A may be liquid crystal displays, organic light-emitting diode displays, laser-based displays, or displays of other types. Optical systems 20B may form lenses that allow a viewer (see, e.g., a viewer's eyes at eye box 24) to view images on display(s) 20. There may be two optical systems 20B (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 20B may be selected so that any gap present between the displays will not be visible to a user (e.g., so that the images of the left and right displays overlap or merge seamlessly).

If desired, optical system 20B may contain a transparent structure (e.g., an optical combiner, etc.) that allows image light from physical objects 28 to be combined optically with virtual (computer-generated) images such as virtual images in image light 38. Light from physical objects 28 in the physical environment or scene can sometimes be referred to and defined herein as world light, scene light, ambient light, external light, or environmental light. In this type of system, a user of system 10 may view both the physical environment around the user and computer-generated content that is overlaid on top of the physical environment. Cameras 14 may also be used in device 10 (e.g., in an arrangement in which a camera captures images of physical object 28 and this content is modified and presented as virtual content at optical system 20B).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

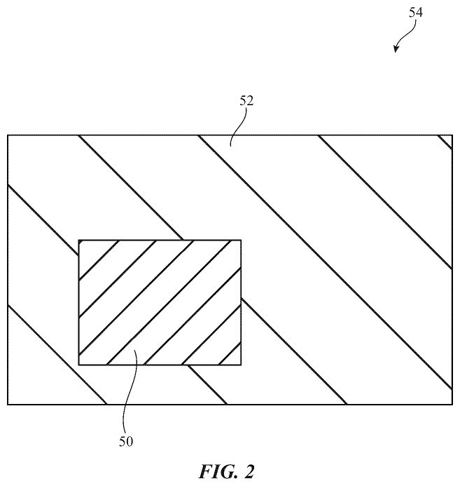

Display 20 (e.g., a single display module or a pair of display modules for respective left and right eyes of the user) may be configured to display an output such as output 54 within the user's field of view (see, e.g., FIG. 2). As shown in FIG. 2, the display output 54 can have a region 50 that includes sensitive data/content and another region 52 that includes non-sensitive data/content. Region 50 in which sensitive data/content is presented can optionally be overlaid on top of region 52 in which non-sensitive data/content is presented. The “sensitive” data/content can, for example, refer to and be defined herein as information including image data captured using outward-facing camera(s) 14 or other sensors configured to acquire information relating to the physical environment surrounding system 10. The sensitive data/content can optionally include computer-generated (virtual) content or other information associated with the user of system 10. To help protect the privacy of users, any personal user information that is gathered by cameras or sensors of system 10 may be handled using best practices. These best practices including meeting or exceeding any privacy regulations that are applicable. Opt-in and opt-out options and/or other options may be provided that allow users to control usage of their personal data.

In contrast, the non-sensitive data/content presented in region 52 can refer to and be defined herein as information including a black background, a white background, a background of any color to help enhance the visibility of the content in region 50, a blurred background, a generic background image related or unrelated to the content in region 50, content that is unrelated to the user or the privacy of the user, content that is unrelated to the physical surrounding of system 10, computer-generated (virtual) content, text optionally associated with the content in region 50, and/or other generic information. Region 52 is therefore sometimes referred to as a background region. Region 52 can also be a foreground region that is optionally overlaid in front of region 50. The example of FIG. 2 in which display output 54 includes one smaller region 50 overlaid on top of a larger region 52 is merely illustrative. If desired, display output 54 can include multiple separate/independent regions 50 having sensitive data/content that are overlaid on top of or behind region 52. Output 54 can also optionally include more than one region 52. Region(s) 52 can optionally be smaller than one or more of regions 50.

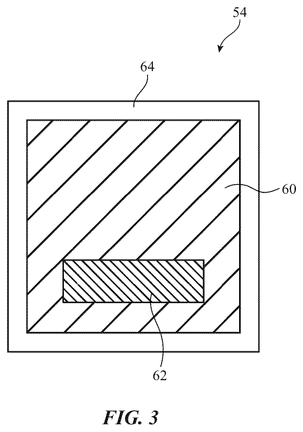

FIG. 3 is a diagram of an exemplary display output 54 having sensitive content captured by a camera and having non-sensitive content such as virtual content. As shown in FIG. 3, region 60 may include a portion of an image captured using one or more outward-facing cameras 14 of system 10. The image shown in region 60 can, as an example, be a magnified version of an actual object as it appears to the user in the physical environment (e.g., the image of the object as presented in display output 54 may appear larger to the user than the actual object itself within the physical environment). In the example of FIG. 3, the image in region 60 can be overlaid in front of a background 64. Background 64 can be a white background, a black background, a gray background, a blurred background, or other background. A text box 62 can optionally be displayed in front of region 60 as shown in FIG. 3 or optionally somewhere within the background region 64. Text box 62 can include text related to the image in region 60, text describing some aspect of the physical environment surrounding system 10, text describing some user interface (UI) function offered by system 10, or other description. This example in which region 62 represents a text box is illustrative. In general, region 62 can include other graphical user interface element(s) or any type of virtual content.

The example described above in which a magnification application configured to magnify a portion of the real-world (physical) environment surrounding system 10 is illustrative. To help improve the overall security and privacy of system 10, it may be desirable to prevent the magnification application (as an example) or other accessibility applications running on system 10 from accessing the sensitive data such as the raw images captured by camera(s) 14, sometimes referred to herein as camera images.

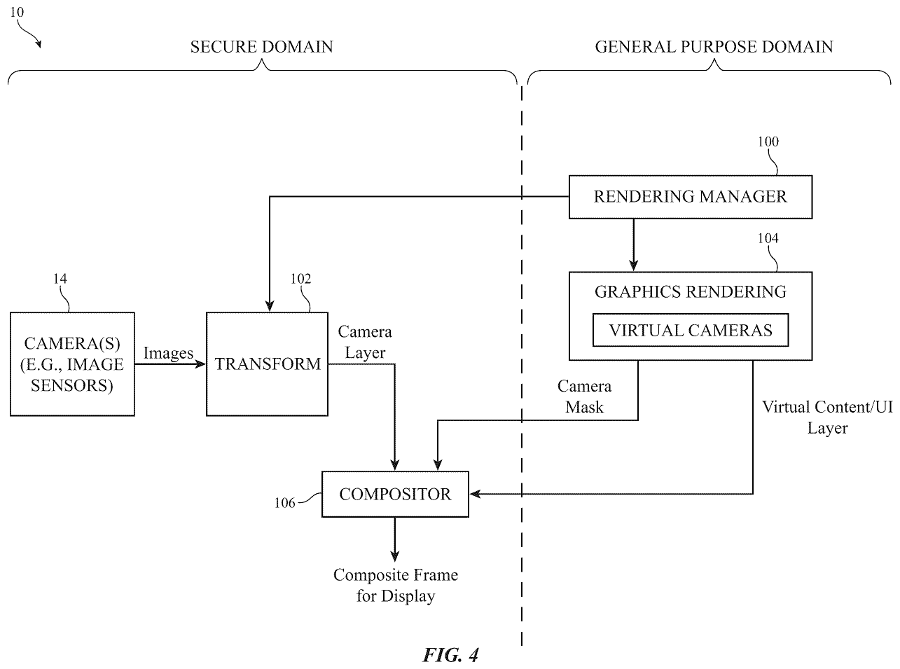

FIG. 4 shows a diagram of system 10 (e.g., a head mounted device) that can be provided with hardware and/or software subsystems configured to generate a display output of the type described in connection with FIGS. 2 and 3. The display output can be disposed any position within the user's field of view such that elements of the display output appear with the correct perspective based on the current user's head pose and orientation. A first portion of the subsystems within device 10 can be considered part of a secure domain, whereas a second portion of the subsystems within device 10 can be considered part of a general purpose domain. The subsystems within the secure domain are therefore sometimes referred to and defined herein as secure subsystems or secure domain subsystems, whereas the subsystems within the general purpose domain are sometimes referred to and defined herein as general purpose subsystems or general purpose domain subsystems. Only the secure subsystems has access to the sensitive data (e.g., camera images), whereas the general purpose subsystems are blocked from accessing the camera images. Configured in this way, even if the subsystems within the general purpose domain is somehow compromised, the general purpose subsystems cannot access any sensitive data.

One or more subsystems within the secure domain may run secure software such as a secure operating system (OS) or kernel, whereas one or more subsystems within the general purpose domain may run a general purpose software such as a general purpose operating system (OS) or kernel. A general purpose software may be defined herein as an operating system, code, or program that has not been formally verified. In contrast, a secure software may refer to or be defined herein as an operating system or program with a smaller piece of code than that of the general purpose software, where the code of the secure OS has been formally verified and is more resistant to undesired or unintended changes in functionality arising from user action or third parties in comparison to the general purpose software. Unlike the general purpose software, the secure software can have a higher level of execution privileges such as privileges to handle sensitive data. This example in which the secure software and the general purpose software are separate operating systems running in parallel is illustrative. As another example, the secure software and the general purpose software may be separate partitions or portions of one operating system. As another example, the secure software and the general purpose software may be concurrent kernels with different codes. The secure software and the general purpose software can be executed on a single processor (e.g., a central processing unit or other types of processor). In other embodiments, the secure software and the general purpose software can be executed on separate processors.

As shown in FIG. 4, the subsystems of the secure domain may include one or more cameras 14, a transform subsystem such as transform block 102, a compositor subsystem such as compositor 106, and/or other secure subsystems. In general, transform block 102 and compositor 106 can be implemented on one or more processors within control circuitry 16 (see FIG. 1). As an example, transform block 102 and compositor 106 may be implemented on a single processing unit such as a central processing unit (CPU). As another example, transform block 102 and compositor 106 can be implemented on separate processing units (e.g., block 102 can be implemented on a first processor, whereas compositor 106 is implemented on a second processor separate from the first processor).

On the other hand, the subsystems of the general purpose domain may include a rendering management subsystem such as rendering manager 100, a graphics rendering subsystem such as graphics renderer 104, and/or other general purpose or non-secure subsystems. Camera(s) 14 may be one or more outward-facing image sensors configured to capture an image of the 3-dimensional (3D) physical environment or scene in which device 10 is being operated. Raw images captured using cameras 14 may include visual information that is seen by the user during operation of device 10 and may thus sometimes be considered to be “sensitive” information. In an effort to limit access to such sensitive information, the raw camera images remain entirely within the secure domain. The raw camera images remaining entirely within the secure domain is therefore sometimes referred to herein as secure camera data. The camera images should, however, not be conveyed to the general purpose domain (e.g., the camera image pixels are isolated from the general purpose domain). Camera pixels that are isolated from the general purpose domain and that remain entirely within the secure domain are sometimes referred to as secure camera pixels.

The camera images can be conveyed to image transform block 102. Image transform block 102 may be configured to perform an image transform operation by reprojecting the captured image from world space to display/screen space mapped onto a certain geometrical shape. The term “world space” may refer to and be defined herein as a 3-dimensional (3D) coordinate system for representing objects and the layout of the physical environment or scene. The term “display/screen space” may refer to and be defined herein as a 2-dimensional (2D) coordinate system for representing elements in a final image being displayed by device 10. The display space is sometimes referred to as the view space. The transformation from world space to display/view space can thus involve projecting a 3D object onto a 2D plane while considering factors like perspective, position, orientation, or other camera parameters. As examples, the image transform operation being performed at block 102 can include translation, rotation, warping, scaling, and/or other image transform functions.

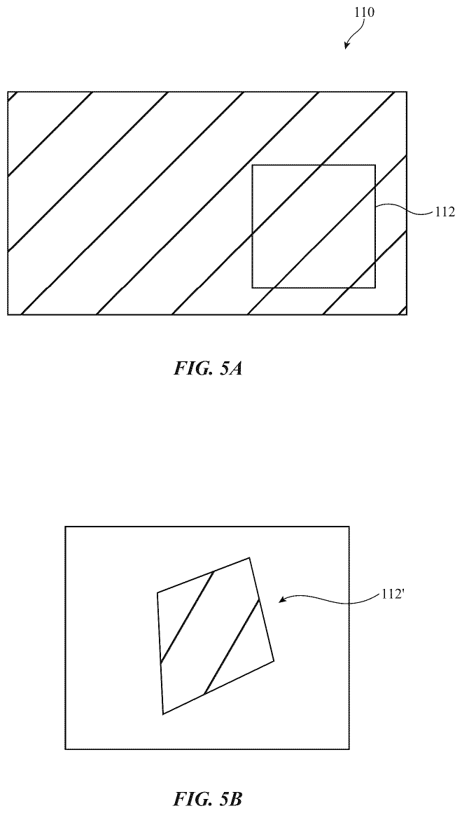

FIG. 5A is a diagram of an illustrative image 110 that is captured by one or more cameras 14. The captured (raw) image 110 can be conveyed to image transform block 102 for further processing. In accordance with an embodiment, a portion of the captured image 110 such as portion 112 can be transformed by block 102. Portion 112 being transformed or otherwise altered at block 102 can be defined or delineated by some geometrical shape (see, e.g., rectangular outline of portion 112). The rectangular shape or geometry of portion 112 is exemplary. In general, the shape of portion 112 can be rectangular, square, triangular, circular, hexagonal, pentagonal, octagonal, a shape with only curved edges, a shape with only straight edges, a shape with a combination of straight and curved edges, or other predetermined (known) shape. FIG. 5B is a diagram of an illustrative transformed image 112′ in the display (view) space. As shown in FIG. 5B, the transformed image 112′ has been reprojected to account for any changes in perspective, orientation, and position in the user's field of view. A transformed image 112′ of the type generated in this way in the 2D display/view space can be considered part of a “camera layer” output from block 102. Transformed image 112′ is sometimes referred to as a processed image. The camera layer can include camera pixels each having a camera pixel value. The shape of transformed image 112′ may be identical to or determined based on the shape of the rendered camera mask.

Referring back to FIG. 4, graphics renderer 104 within the general purpose domain can be configured to generate a masking layer and a virtual content layer. The graphics renderer 104, sometimes referred to as a graphics rendering engine or a graphics rendering pipeline, can be configured to render or generate virtual content (e.g., virtual reality content, augmented reality content, mixed reality content, or extended reality content) or may be used to carry out other graphics processing functions. The virtual content output from graphics rendering engine 104 may generally include non-sensitive content and can be considered to be part of a virtual content layer. The virtual content can optionally include a visual affordance such as some representation of a button, a text field, a label, an icon, a box, a menu, a slider, a tab, a progress bar, a scrollbar, a grid, a table, a combination of these elements, and/or other user interface elements (e.g., graphics user interface elements). The virtual content layer can therefore sometimes also be referred to as a user interface (UI) layer.

Graphics rendering engine 104 can be implemented on a graphics processing unit (GPU), as an example. Graphics renderer 104 can synthesize photorealistic or non-photorealistic images from one or more 2-dimensional or 3-dimensional model(s) defined in a scene file that contains information on how to simulate a variety of features such as information on shading (e.g., how color and brightness of a surface varies with lighting), shadows (e.g., how to cast shadows across an object), texture mapping (e.g., how to apply detail to surfaces), reflection, transparency or opacity (e.g., how light is transmitted through a solid object), translucency (e.g., how light is scattered through a solid object), refraction and diffraction, depth of field (e.g., how certain objects can appear out of focus when outside the depth of field), motion blur (e.g., how certain objects can appear blurry due to fast motion), and/or other visible features relating to the lighting or physical characteristics of objects in a scene. Graphics renderer 72 can apply rendering algorithms such as rasterization, ray casting, ray tracing, radiosity, or other graphics processing algorithms.

In the embodiment of FIG. 4, graphics rendering block 104 can have associated rendering parameters sometimes referred to and defined herein as “virtual cameras.” The virtual cameras associated with the graphics renderer 104 may represent constraints imposed on the graphics rendering operations that define the perspective or point of view for rendering the virtual content for the user's eyes. For example, the virtual cameras can include: (1) a first virtual (render) camera that determines the perspective from which the virtual content generated for the left eye (sometimes referred to and defined herein as “left eye content” or left eye virtual content) will be rendered, and (2) a second virtual (render) camera that determines the perspective from which the virtual content generated for the right eye (sometimes referred to and defined herein as “right eye content” or right eye virtual content) will be rendered. The left virtual camera is therefore sometimes referred to herein as a first point of view (POV) or perspective rendering parameter, whereas the right virtual camera is sometimes referred to herein as a second POV or perspective rendering parameter. The virtual rendering cameras are therefore sometimes referred to collectively as view rendering parameters or constraints. The view rendering parameters may have values that are a function of the current head pose, orientation, and/or motion of the user as measured using one or more sensors 18 in device 10 (see, e.g., FIG. 1).

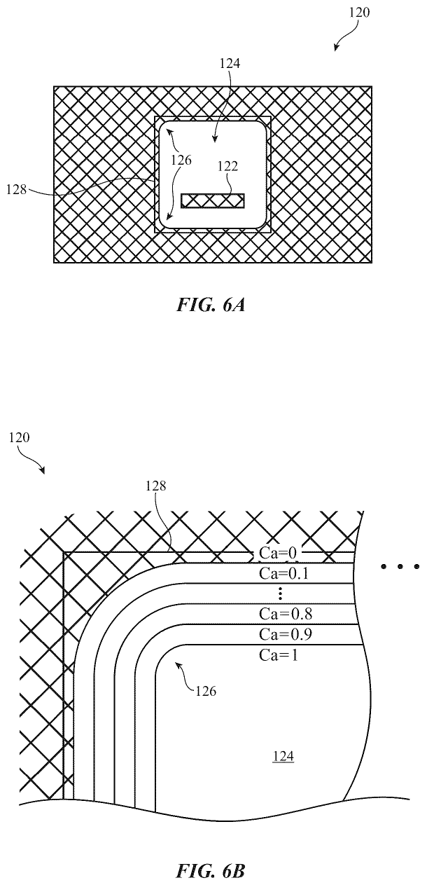

The graphics rendering engine 104 may also be configured to generate a masking layer. The masking layer may include a mask that defines which regions or pixels of an image should be considered or ignored. For example, the masking layer can include a mask that defines which regions or pixels of a camera image can be ultimately displayed and which regions or pixels of the camera image should be masked or blocked in the final display output. This type of mask is sometimes referred to and defined herein as a camera mask. A masking layer that includes a camera mask can be referred to as a camera mask layer. FIG. 6A is a diagram of an illustrative camera mask such as camera mask 120. Camera mask 120 can be configured to selectively control the visibility or transparency of certain parts of an associated camera image. As shown in the example of FIG. 6A, camera mask 120 can have one or more “transparent” portions (see shaded portions of the mask) that mask the corresponding portions of the camera image such that the masked portions are concealed without any transparency or blending. Camera mask 120 can also have one or more “opaque” portions such as portion 124 (see non-shaded portion of the mask) through which the corresponding portions of the camera image are revealed. Opaque masking portion 124 is therefore sometimes referred to as a visible mask portion. Opaque portion 124 can also surround a smaller transparent portion 122. Opaque portion 124 of the camera mask 120 can optionally have straight edges joined by rounded or curved corners 126. If desired, opaque portion 124 can alternatively or additionally have one or more sharp corners (e.g., 90 degree corners).

The opaque portion 124 of camera mask 120 may be defined by a camera mask shape such as camera mask shape 128. Camera mask shape 128 may be a shape that is at least equal to or larger than opaque (visible) portion 124. In practice, areas of camera mask 120 outside the camera mask shape box can optionally be omitted since any camera pixels in the transparent portions will be concealed. The rectangular shape or geometry of camera mask shape 128 is exemplary. In general, the camera mask shape 128 may be rectangular, square, triangular, circular, hexagonal, pentagonal, octagonal, a shape with only curved edges, a shape with only straight edges, a shape with a combination of straight and curved edges, or other predetermined (known) shape. Although the camera mask shape 128 is shown as being rectangular in the example of FIG. 6A, camera mask shape 128 may actually have a transformed or projected shape that is similar or identical to the geometry of the transformed image 112′ as illustrated in the example of FIG. 5B. In other words, graphics rendering engine 104 can render camera mask 120 (and also the virtual content layer) based on the perspective, orientation, and position of the final display output within the user's field of view (e.g., by adjusting the virtual cameras so that camera mask shape 128 is projected in world space).

Camera mask 120 is often implemented as a grayscale image having alpha channels associated with the camera image. Camera mask 120 can have alpha values that determine the level of transparency/opacity of each corresponding pixel in the camera image. An alpha value of 0—illustrated by the color black—indicates full transparency (i.e., the underlying pixel will be hidden), whereas an alpha value of 1—illustrated by the color white—indicates full opacity of the underlying pixel (i.e., the underlying pixel will be visible). Intermediate gray values between 0 and 1 in the mask indicate partial transparency. In general, alpha blending or compositing may refer to an image processing technique for combining multiple content layers with varying levels of transparency. Alpha blending can involve blending the colors of the foreground pixels and background pixels based on alpha values, sometimes also known as alpha channels. The alpha values used in such alpha blending operations are therefore sometimes referred to as alpha blending values. Camera mask 120 is therefore sometimes referred to more generically as an alpha mask.

FIG. 6B is a diagram showing illustrative alpha blending values along a periphery of camera mask 120. As shown in FIG. 6B, camera mask 120 can have alpha blending values Ca that range from a value of “1” in the fully opaque portion and gradually fading to a value of “0” in the fully transparent portion 124. A graduation or fading of alpha values along the edges of camera mask 120 can help produce a more smooth and rounded appearance, especially along curved corner portion 126. If desired, the edges of opaque portion 122 (see FIG. 6A) can also be provided with a similar graduation of alpha blending values.

Referring back to FIG. 4, transform block 102 and graphics rendering engine 104 can be programmed or controlled by rendering manager 100. Rendering manager 100 can reside in the general purpose domain and can be configured to initiate rendering operations at graphics rendering engine 104 while simultaneously directing the transform block 102 residing in the secure domain to transform a raw camera image. Rendering manager 100 can also coordinate the various blending modes that are used for combining the various content layers (e.g., for compositing the camera layer, the masking layer, the virtual content or UI layer, and/or other image layers). The camera layer output from transform block 102 (which can include a transformed camera image), the camera mask output from graphics rendering engine 104, and the virtual content (and optionally UI elements) layer output from graphics rendering engine 104 can all be fed into a compositor 106 residing in the secure domain. Since compositor 106 belongs in the secure domain, it can be allowed to handle potentially sensitive data such as a camera image.

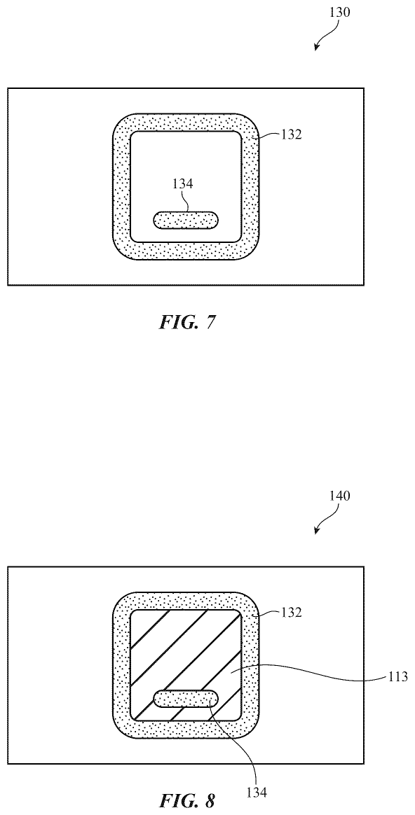

Compositor 106 can be configured to combine, composite, or merge the three layers that it receives. The camera layer can be a transformed camera image of the type described in connection with FIG. 5B. The mask layer can be a camera mask of the type described in connection with FIGS. 6A and 6B. The virtual content (UI) layer can include virtual content of the type shown in FIG. 7 (as an example). As shown in the example of FIG. 7, virtual content layer 130 can include a first portion such as portion 132 and a second portion such as portion 134. Portion 132 can be a white border, a border for an icon, button, or other graphic user interface element, or other border element. Portion 134 can include text or other types of labeling or description. In general, portion 134 can include any type of content, including but not limited to virtual content. If desired, virtual content layer 130 can include other types of virtual content or user interface elements.

Compositor 106 can be configured to combine the camera layer, the camera mask, and the virtual content (UI) layer via a multiply-add operation to generate a composite image (frame) for the display output. For example, compositor 106 can compute a product of the camera layer and the camera mask (e.g., by multiplying the camera layer with the camera mask) and then compute a sum of the product and the virtual content layer to produce the composite image. FIG. 3 shows an example of a composite image. FIG. 8 shows another example of a composite image such as composite output 140 that can be presented by one or more displays 20 of device 10, sometimes referred to as a composite output for display or a composite display output. As shown in FIG. 8, composite display output 140 can include a portion of the transformed image 113 that remains from the masking function of the camera mask (see, e.g., camera mask 120 of FIG. 6A, which conceals portions of the transformed image blocked by the opaque portions of the camera mask). This operation can be achieved via a multiply operation between the camera layer and the camera mask. The version of the transformed image produced from this multiplication or camera image masking operation is sometimes referred to and defined herein as a masked camera image.

The virtual content layer such as virtual content layer 130 of FIG. 7 can be overlaid on top of the masked camera image to produce the exemplary composite display output 140 of FIG. 8. This overlay operation can be achieved via a summing or addition operation. In the example of FIG. 8, the border portion 132 of virtual content layer 130 can run along the outer periphery of the masked camera image. Moreover, portion 134 of the virtual content layer 130 can fill in a masked out portion of the masked camera image corresponding to opaque portion 122 of the camera mask (see, e.g., FIG. 6A). The final display output 140 of FIG. 8 is merely illustrative. In general, the composite image generated by compositor 106 can include one or more camera images at least a portion of which is masked by a masking layer, any type of virtual content, one or more graphical user interface (GUI) elements, and/or other sensitive or non-sensitive data or content.

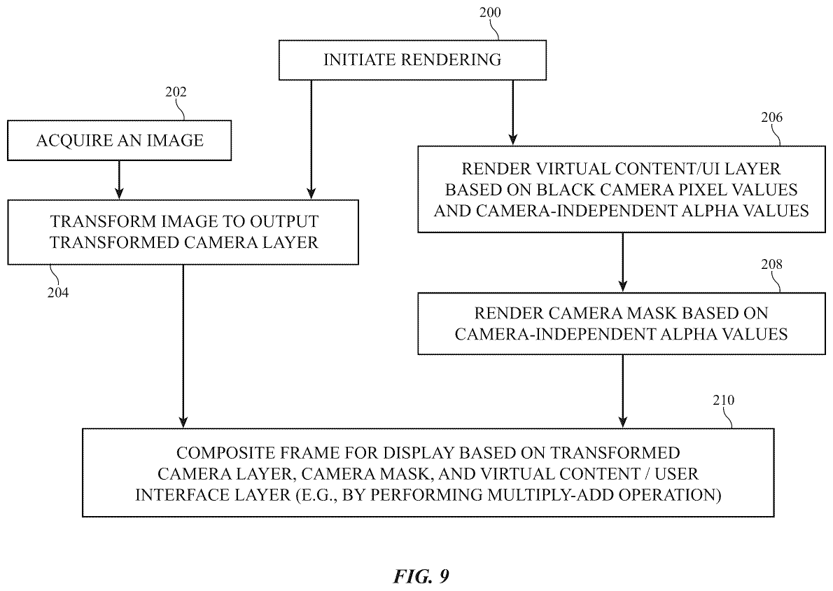

FIG. 9 is a flow chart of illustrative steps for operating the various subsystems of device 10 of the type described in connection with FIGS. 1-8. During the operations of block 200, rendering manager 100 can initiate rendering operations. For example, rendering manager 100 can initiate rendering operations at graphics rendering engine 104 within the general purpose domain while simultaneously initiating image processing/rendering operations at transform block 102 within the secure domain. Rendering manager 100 can optionally coordinate the various blend modes used for rendering the various content at the graphics rendering engine 104 and the transform block 102.

During the operations of block 202, one or more outward facing cameras 14 or other image sensors within device 10 can acquire or capture an image of a physical environment or scene. Although block 202 is labeled with a higher reference number than block 200, the operations of block 202 need not be performed after the operations of block 200 and can optionally be before or in parallel with the operations of block 200. The image captured by an outward-facing camera 14 can be referred to as a camera image.

During the operations of block 204, transform block 102 can receive the camera image acquired during the operations of block 202 and process the received camera image to produce a corresponding transformed camera image, sometimes referred to as being part of a camera layer or a transformed camera layer. Transformed block 102 can transform the camera image based on a camera mask shape. The operations of block 204 can be initiated or triggered in response to the operations of block 200.

During the operations of block 206, graphics rendering engine 104 can be configured to render a virtual content layer optionally containing one or more graphical user interface (GUI) elements. Graphics rendering engine 104 an render the virtual content layer based on black camera pixel values and associated camera alpha values that do not depend on the actual camera pixel values. Such alpha values being used for blending the camera pixels with other content layers but are not a function of the camera pixel values are sometimes referred to and defined herein as camera-independent alpha values. This example in which the alpha values are independent of the actual camera pixel values is illustrative. In other embodiments, the alpha values can optionally depend on or be based on the camera pixel values. For instance, a subsystem in the secure domain can be configured to create an alpha mask from the camera image, and the shape of the alpha mask might not be considered sensitive information. The operations of block 206 can be initiated or triggered in response to the operations of block 200.

During the operations of block 208, graphics rendering engine 104 can be configured to render a camera mask based on the same camera independent alpha values that are used for the operations of block 206. The operations of block 208 can be initiated or triggered in response to the operations of block 200. Although the operations of block 208 are shown as occurring after block 206, the operations of block 208 can be performed before or in parallel with the operations of block 206.

During the operations of block 210, compositor 106 can be configured to produce a composite image (frame) for display based on the transformed camera layer output from the operations of block 204, the virtual content (UI) layer output from the operations of block 206, and the camera mask output from the operations of block 208. For example, compositor 106 can combine the various content layers by performing a multiply-add operation (e.g., compositor 106 can multiply the transformed camera layer with the camera mask and then add the corresponding product with the virtual content layer to produce the final display output). Generating a composite image frame in this way is technically advantageous and beneficial since it allows the graphics rendering engine 104 to independently render a camera mask layer and virtual content (UI) layer without knowing or accessing the camera pixel values, which remain hidden in the secure domain.

The operations of FIG. 9 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

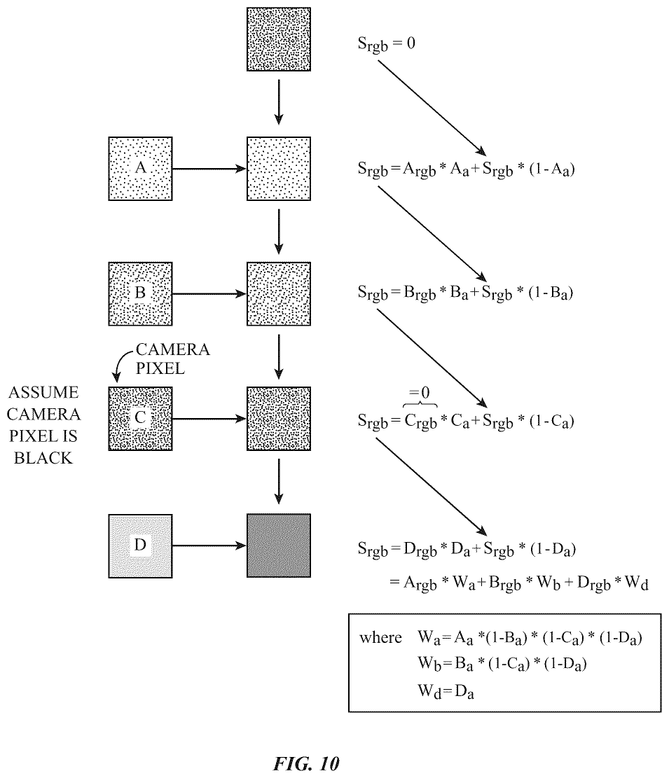

FIG. 10 is a diagram showing how an illustrative pixel in the virtual content layer can be rendered by graphics rendering engine 104 during the operations of block 206 of FIG. 9. In general, alpha blending operations can perform linear interpolation to combine two colors based on an associated alpha value. The process may start with a background pixel and then successively blending in one or more foreground pixels one layer at a time, as shown in the following expression:

$$C\_blend = F * α + B * ( 1 - α ) \qquad ( 1 )$$

where C_blend represents the final blended color, where F represents the color of the foreground pixel, where B represents the color of the background pixel, and where a represents the alpha value, sometimes referred to as the alpha channel value of the foreground pixel or the interpolation factor. The alpha value a determines the weight given to the foreground and background pixel colors in the final blended color. The alpha value a can range from a value of “0” (fully transparent) to a value of “1” (fully opaque). Thus, as the alpha value a increases, the contribution from the foreground pixel color would increase, and the resulting color would be skewed towards the color of the foreground pixel. Conversely, as the alpha value a decreases, the contribution from the background pixel color would increase, and the color of the background pixel would become more prominent. A pixel color can include red, green, and blue channels and is therefore sometimes labeled “Srgb,” as shown in the example of FIG. 10.

As shown in FIG. 10, the starting background pixel may be black, as indicated by an Srgb value of “0.” A first foreground pixel A can then be blended with the background pixel in accordance with a first alpha value Aa to produce a first blended pixel. In the example of FIG. 10, pixels A, B, and D may be considered non-camera pixels (e.g., pixels that are not produced by a camera), pixels belonging to the virtual content layer, or pixels containing non-sensitive data. A second foreground pixel B can then be blended with the first blended pixel in accordance with a second alpha value Ba to produce a second blended pixel. A third foreground pixel C can then be blended with the second blended pixel in accordance with a third alpha value Ca to produce a third blended pixel. Here, assuming the third foreground pixel C is a camera pixel, then camera pixel C, which is unknown or hidden from graphics rendering engine 104, can be assumed to be black (e.g., Crgb is set equal to “0” as a placeholder). The third alpha value Ca associated with the camera pixel C can be a camera-independent alpha value. Alpha value Ca associated with a camera pixel can be defined herein as a “camera pixel blending alpha value.” The camera pixel blending alpha value Ca may be based on a camera mask shape known by rendering engine 104 (see, e.g., shape 128 of FIG. 6A). The shape of the camera mask may be provided by rendering manager 100 to graphics rendering engine 104 during the operations of block 200. Illustrative camera-independent alpha values are shown in the example of FIG. 6B. Each camera pixel can have its own respective alpha value.

A fourth foreground pixel D can then be blended with the third blended pixel in accordance with a fourth alpha value Da to produce a fourth blended pixel. Here, the fourth (final) blended pixel can have a resulting color expressed as a weighted sum:

$$Srgb = ( Argb * Wa ) + ( Brgb * Wb ) + ( Drgb * Wd ) \qquad ( 2 )$$

where Argb represents the color of the first foreground pixel A, where Brgb represents the color of the second foreground pixel B, where Drgb represents the color of the fourth foreground pixel D, and where Wa, Wb, and Wd represent various weights or weighting factors defined as follows:

$$Wa = Aa * ( 1 - Ba ) * ( 1 - Ca ) * ( 1 - Da ) \qquad ( 3 )$$

$$Wb = Ba * ( 1 - Ca ) * ( 1 - Da ) \qquad ( 4 )$$

$$Wd = Da \qquad ( 5 )$$

The example of FIG. 10 in which the final blended pixel of the virtual content layer is computed based on four layers of foreground pixels is merely illustrative. In general, the virtual content (UI) layer can be rendered based on two or more layers that are successively blended together, three or more layers that are successively blended together, four or more layers that are successively blended together, five to ten layers that are successively blended together, or more than ten layers that are successively blended together.

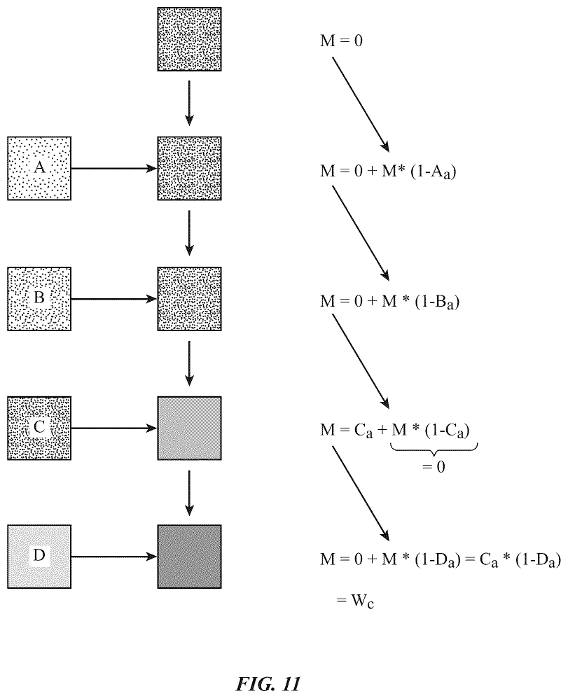

FIG. 11 is a diagram showing how an illustrative pixel in the camera mask can be rendered by graphics rendering engine 104 during the operations of block 208 of FIG. 9. Alpha blending operations via linear interpolation can also be used to render the camera mask. As shown in FIG. 11, the starting background pixel may be black, as indicated by a mask value M being equal to “0.” When rendering the camera mask, non-camera pixels are only capable of reducing the value of the camera mask. Since the camera mask is initiated to a black (0) value, it cannot be reduced any further by non-camera pixels. On the other hand, camera pixels can raise the value of the camera mask to a non-zero value. Only after the camera mask has been raised to a non-zero value can subsequent non-camera pixels actually reduce the value of the camera mask. In the example of FIG. 11, pixels A, B, and D may be considered non-camera pixels (e.g., pixels that are not produced by a camera), pixels belonging to the virtual content layer, or pixels containing non-sensitive data.

A first foreground pixel A can then be blended with the background pixel in accordance with a first alpha value Aa to produce a first blended pixel. Since the first foreground pixel A is a non-camera pixel, then the blended mask value M remains at zero. A second foreground pixel B can then be blended with the first blended pixel in accordance with a second alpha value Ba to produce a second blended pixel. Since the second foreground pixel B is a non-camera pixel, then the blended mask value M remains at zero. A third foreground pixel C can then be blended with the second blended pixel in accordance with a third alpha value Ca to produce a third blended pixel. Here, assuming the third foreground pixel C is a camera pixel, then camera pixel C raise or increase the blended mask value M by a third alpha value Ca associated with the camera pixel. As shown in FIG. 11, the third blended pixel can have a non-black value. Alpha value Ca of the camera pixel C can be a camera-independent alpha value. Alpha value Ca associated with a camera pixel can be defined herein as a “camera pixel blending alpha value.” The camera pixel blending alpha value Ca may be based on a camera mask shape known by rendering engine 104 (see, e.g., shape 128 of FIG. 6A). The shape of the camera mask may be provided by rendering manager 100 to graphics rendering engine 104 during the operations of block 200. Illustrative camera-independent alpha values are shown in the example of FIG. 6B.

A fourth foreground pixel D can then be blended with the third blended pixel in accordance with a fourth alpha value Da to produce a fourth blended pixel. Here, the fourth (final) blended pixel can have a resulting mask value expressed as follows:

$$M = Ca * ( 1 - Da ) = Wc \qquad ( 6 )$$

where Ca represents the camera-independent alpha value of the camera pixel and where Da represents the alpha value of the fourth foreground pixel D. This final mask value can be defined as being equal to another weight factor Wc. The example of FIG. 11 in which the final value of the masking layer is computed based on four layers of foreground pixels is merely illustrative. In general, the camera mask can be rendered based on two or more layers that are successively blended together, three or more layers that are successively blended together, four or more layers that are successively blended together, five to ten layers that are successively blended together, or more than ten layers that are successively blended together.

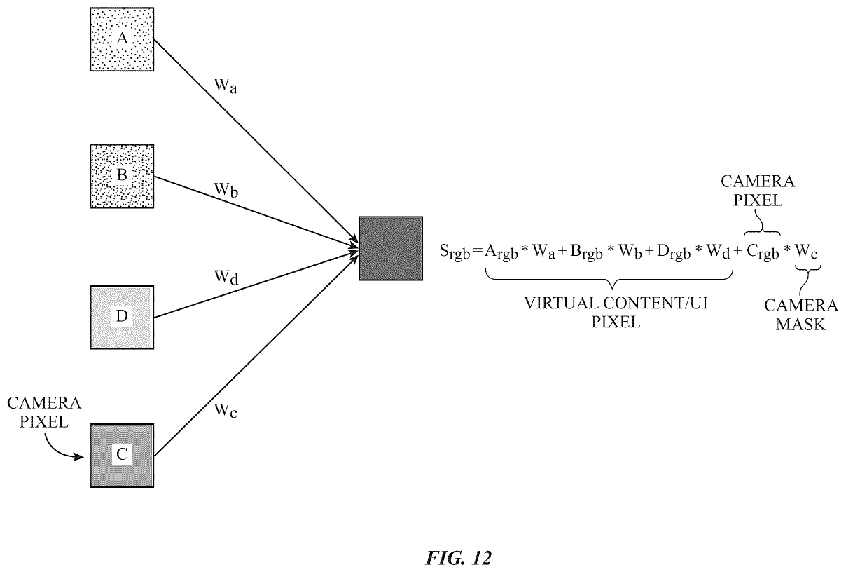

FIG. 12 is a diagram showing how the operations of the type described in connection with FIGS. 9-11 can achieve alpha blending via a weighted sum approach in accordance with some embodiments. As shown in FIG. 12, the final composite pixel can have a pixel value Srgb expressed as follows:

$$Srgb = [ ( Argb * Wa ) + ( Brgb * Wb ) + ( Drgb * Wd ) ] + ( Crgb * Wc ) \qquad ( 7 )$$

where Crgb represents the camera pixel value from the camera layer. In other words, the composite pixel value can be written as a weighted sum, where pixel value Argb is scaled by weighting factor Wa as defined in equation 3, where pixel value Brgb is scaled by weighting factor Wb as defined in equation 4, where pixel value Drgb is scaled by weighting factor Wd as defined in equation 5, and where camera pixel value Crgb is scaled by weighting factor Wc as defined in equation 6.

In equation 7, the term within the brackets is identical to the expression defined in equation 2. Thus the weighted sum of equation 7 can effectively be computed by the sum of the term within the brackets, which is equal to a pixel value of the virtual content (UI) layer, and a product of camera pixel value Crgb and Wc, which is the camera mask value. In other words, the weighted sum of equation 7 can be computed via the operations of block 210 of FIG. 9 (e.g., via a multiply-add operation). The exact order of operations for computing the weighted sum of equation 7 can vary. In other words, processing of the camera pixel C can optionally be pushed to the very end, and the various content layers can be rendered in parallel until the camera pixel value Crgb becomes available for the final compositing step. Computing composite image pixel values in this way can therefore be technically advantageous and beneficial since this allows the camera pixel and other potentially sensitive data to be processed entirely within the secure domain while the camera mask, the virtual content layer, and/or other non-sensitive data can be separately processed in parallel within the general purpose domain even when the camera pixels are not the last foreground pixel as illustrated in the examples of FIGS. 10 and 11.

The foregoing is merely illustrative and various modifications can be made to the described embodiments. The foregoing embodiments may be implemented individually or in any combination.

What is claimed is:

1. A method of operating an electronic device, comprising:
with one or more image sensors within a secure domain, acquiring an image;
with a first subsystem within a general purpose domain separate from the secure domain, rendering one or more content layers;
with a second subsystem within the secure domain, processing the acquired image to produce a processed image without conveying the acquired image to the general purpose domain; and
with a third subsystem within the secure domain, combining the processed image with the one or more content layers.

2. The method of claim 1, wherein the first subsystem comprises a graphics rendering engine, and wherein rendering the one or more content layers comprises:
with the graphics rendering engine, rendering a virtual content layer.

3. The method of claim 2, wherein the virtual content layer comprises one or more user interface elements.

4. The method of claim 2, wherein rendering the one or more content layers further comprises:
with the graphics rendering engine, rendering a camera mask.

5. The method of claim 4, wherein the second subsystem comprises an image transform subsystem, and wherein processing the acquired image to produce the processed image comprises transforming the acquired image based on perspective information.

6. The method of claim 5, wherein the third subsystem comprises a compositor subsystem, and wherein combining the processed image with the one or more content layers comprises:
with the compositor subsystem, computing a product of the processed image and the camera mask.

7. The method of claim 6, wherein combining the processed image with the one or more content layers further comprises:
with the compositor subsystem, computing a sum of the product and the virtual content layer.

8. The method of claim 1, further comprising:
with a rendering management subsystem within the general purpose domain, controlling blending operations at the first subsystem within the general purpose domain and blending operations at the second subsystem within the secure domain.

9. A method of operating an electronic device, comprising:
with one or more cameras, acquiring an image having camera pixel values;
with a graphics rendering engine, rendering a camera mask having alpha values that are independent of the camera pixel values; and
with a compositor, masking the image with the camera mask.

10. The method of claim 9, further comprising:
obtaining the alpha values based on a shape of the camera mask.

11. The method of claim 10, wherein the alpha values comprise gradually increasing or decreasing alpha values along an edge of the shape of the camera mask.

12. The method of claim 10, further comprising:
before masking the image with the camera mask, transforming the image based on the shape of the camera mask.

13. The method of claim 9, further comprising:
with the graphics rendering engine, rendering a virtual content layer; and
with the compositor, adding the virtual content layer to the masked image.

14. The method of claim 9, wherein:
the graphics rendering engine is part of a general purpose domain;
the one or more cameras and the compositor are part of a secure domain that is separate from the general purpose domain; and
the camera pixel values of the acquired image remain entirely within the secure domain and are isolated from the general purpose domain.

15. A method of operating an electronic device, comprising:
with one or more cameras, acquiring an image having camera pixel values;
with a graphics rendering engine, rendering a virtual content layer based on black camera pixel values;
processing the acquired image to produce a processed image; and
producing a composite image based on the processed image and the virtual content layer.

16. The method of claim 15, wherein rendering the virtual content layer comprises:
blending the black camera pixel values with foreground pixel values based on alpha values that are independent of the camera pixel values.

17. The method of claim 15, further comprising:
with the graphics rendering engine, rendering a camera mask; and
masking the processed image with the camera mask.

18. The method of claim 17, wherein processing the acquired image to produce the processed image comprises transforming the acquired image based on a shape of the camera mask.

19. The method of claim 17, wherein rendering the camera mask comprises rendering the camera mask based on camera pixel blending alpha values that are independent of the camera pixel values.

20. The method of claim 15, wherein:
the graphics rendering engine comprises a subsystem within a general purpose domain;
the one or more cameras comprises one or more sensors within a secure domain that is separate from the general purpose domain;
the camera pixel values are isolated from the general purpose domain; and
one or more processors in the secure domain are configured to produce the processed image and to produce the composite image.
